(19) United States
(12) Patent Application Publication
(10) Pub. No.: US 2004/0198271 A1
(43) Pub. Date: Oct. 7, 2004

(54) Envelope-tracking amplifier for improving gain, Method for improving efficiency thereof, and terminal device of mobile communication applied to the same

(76) Inventor: In Ho Kang, Busan (KR)

Correspondence Address: G W i P S, Kang Nam, P.O. Box 2301, Seoul, 135-621, KR

(21) Appl. No.: 10/150,923

(22) Filed: May 21, 2002

(51) Int. Cl. H04B 1/04

(52) U.S. Cl. 455/127.1; 330/85

(57) ABSTRACT

An inventive envelope-tracking amplifier is provided for improving gain and efficiency by dynamically shifting an operating point of active element (23) of power amplifying unit (10). A method for improving gain and efficiency is also developed for correcting an impedance of input, output or input/output of active element. An envelope DC current detected from RF signal is applied to variable impedance for radio frequency in an impedance matching circuit. Therefore, the variable impedance resulting from varying a signal level of a power amplifier corrects the variation of input or output impedance of active element by matching with the mated input, output or input/output. As a result, the gain and stability of amplifier is improved. A mobile communication terminal device is possibly adopting the same.

### BACKGROUND OF THE INVENTION

The present invention relates to a device for improving gain and efficiency of a high power amplifier used in the mobile communication terminal devices, and a method for improving efficiency thereof Particularly, it relates to a circuit for correcting a matched circuit according to the impedance variation of active element when a DC voltage supply is varied by a DC-DC converter, and the method for improving efficiency of it.

### DESCRIPTION OF THE BACKGROUND

Generally, a RF power amplifier used for the mobile communication requires high linearity to accurately modulate and limit the frequency playback. To minimize the distortion caused from non-linearity, the power amplifier is operated as class A or class AB. If an output power were less than the maximum during an operation of class A or class AB of the power amplifier, the efficiency would be reduced.

However, the output of terminal device varies in the CDMA or other methods of transmission in order to adapt the multi-channel, shadow fading and various distances between the terminal device and base station. In the wireless communication systems, the RF output is controlled by the active feedback control to limit the interference with the service life of battery. In this case, the probability distribution of output power of terminal device is recently published as illustrated in FIG. 1. An actual output is shown near ImW for a case of approximately 1 W maximum output. Furthermore, it reveals that the output is rarely reached the maximum for a short time. Because the efficiency of class A decreases with a decrease of power, it decreases to 0.1%. For the class AB, the efficiency decreases to 2% since it is inversely proportional to square root.

In order to overcome the inefficiency of conventional batteries, a unique power amplifier is developed. A theory is based on the thesis of Gary Hanington et al. “High-Efficiency Power Amplifier Using Dynamic Power-Supply Voltage for CDMA Applications” (IEEE TRANSACTIONS ON MICROWAVE THEORY TECHNIQUES, VOL. 47, NO. 8, AUGUST 1999, pp. 1471-1476). According to a power amplifier of this thesis, the DC bias value shifts downward as shown in FIG. 2 if the power output of terminal device is lower. Therefore, an operating point is shifted leftward. As shown in FIG. 3 of this thesis, it is possible to shift the operating point if a DC-DC converter reduces the supplying voltage. If the output power of terminal device decreases, the DC voltage and current vary adequately. Therefore, the DC bias power is possibly reduced. Thereby, the efficiency of amplifier enables to maintain relatively high. This kind of amplifier is known as an envelope-tracking amplifier.

### SUMMARY OF THE INVENTION

Even though the overall efficiency is improved compared with the conventional method, the impedance of an input/output terminal of power amplifier is varied due to the shifting of operating point and the power level of terminal device if a supplied voltage were varied by a device such as a DC-DC converter. The variation of impedance of input/output terminals causes the mismatching of power amplifier and reducing the gain. The gain decreasing of power amplifier eventually induces the decreasing efficiency being compared with that of the fixed operating points. Furthermore, the mismatching also causes the impedance variation to increase a reflect coefficient and instability of amplifier.

The object of the present invention is to overcome the foregoing problems and provide an inventive circuit that correct the variation of impedance being occurred due to the variation of power level and shifting of operating point of power amplifier.

To achieve the object set forth, the present invention adopts a radio frequency variable capacitance device, which is a nonlinear semiconductor element, as an impedance correction circuit. When a direct current being detected in the RF signal of power amplifier is applied to the radio frequency variable capacitance device to the inverse direction voltage, the capacitance is formed. If a signal level of power amplifier were varied, the capacitance would also be varied. The varied capacitance enables to modify the variation of impedance being occurred due to the variation of power level and shifting operating point. As a result, it is possible to improve the gain and efficiency of mobile terminal devices by adopting a nonlinear semiconductor element.

Additional object or effect of the present invention will become apparent through the following description with reference to the attached drawings.

According to one of the preferred embodiment, the present invention comprises that: a DC bias voltage supply unit (1) includes a DC-DC converter to apply dynamic DC bias voltage depending on the variation of RF input signal; an envelope tracking amplifier generates a RF output to improve the efficiency by dynamically shifting the operating point of active element (23) of power amplifying unit (10); means (4, 14) for extracting the RF input or output signal; a detector (5, 15) for detecting the envelope signals from the signals extracted by the means (4,14) for extracting the RF signal; a DC controller (24 or 27) for controlling the signal of the detector (5; 15); at least one impedance correcting circuit (100 or 200; 100′ or 200′; 100″ or 200″; 100″a or 200″a) being connected to the input side, output side or input/output side of active element (23); at least one of the radio frequency variable impedance device (26 or 29) being connected to each of output signal of DC controller; and in case of variation either one of the signal level of RF signal or operating point of amplifier, or both, the active element receives the corrected input or output impedance by the impedance correcting circuit and matches to the mating input, output or input/output.

Preferably, at least one impedance correcting circuit (100 or 200) includes each of λ/4 transmission line (25, 28) being connected to one output end of DC controller (24, 27). Simultaneously, at least one radio frequency variable capacitance device (26, 29) is inversely connected to the other end of λ/4 transmission line. The connection is further connected parallel to a gate (base) or drain (collector) of active element.

At least one impedance correcting circuit (100′ or 200′) includes each of λ/4 transmission line (25, 28) being connected to one output end of DC controller (24, 27). At the same time, at least one radio frequency variable capacitance device (26, 29) is connected to the other end of λ/4 transmission line. The other end of radio frequency variable capacitance device is further connected parallel to a gate (base) or drain (collector) of active element.

Among the various arrangements of the impedance correcting circuits, at least one input side of impedance correcting circuit (100″) includes first λ/4 transmission line (25) being connected to one output end of DC controller (24). The other end of first λ/4 transmission line is simultaneously connected to at least one radio frequency variable capacitance device (26). It is further connected to the RF input side. The other end of radio frequency variable capacitance device (26) is connected series to a gate (base) of active element. Among the various arrangements of the impedance correcting circuits, at least one output side of impedance correcting circuit (200″) includes first λ/4 transmission line (28) being connected to one output end of DC controller (27). The other end of first λ/4 transmission line is connected at least one radio frequency variable capacitance device (29). At the same time, the connection is further connected to a drain (collector) side of active element, and the other end of radio frequency variable capacitance device (29) is connected series to the RF output side. At least one other end of the radio frequency variable capacitance device (26, 29) is connected to second λ/4 transmission line (25).

Among the various arrangements of the impedance correcting circuits, at least one input side of impedance correcting circuit (100″a) includes first λ/4 transmission line (25) being connected to one output end of DC controller (24). The other end of λ/4 transmission line is simultaneously connected to at least one radio frequency variable capacitance device (26). It is further connected to a gate (base) of active element. The other end of radio frequency variable capacitance device (26) is connected series to the RF input side. Among the various arrangements of the impedance correcting circuits, at least one output side of impedance correcting circuit (200″a) includes first λ/4 transmission line (28) being connected to one output end of DC controller (27). The other end of first λ/4 transmission line is connected at least one radio frequency variable capacitance device (29). At the same time, the connection is further connected to the RF output side, and the other end of radio frequency variable capacitance device (29) is connected series to a drain (collector) side of active element.

More preferably, a bypass capacitor (C1, C2) being grounded one end is connected to a contacting point of output end of DC controller (24, 27) and the λ/4 transmission line (25, 28). At least one anode of radio frequency variable capacitance device is connected to an inductor (I11;I12), and one end of inductor is grounded.

At least one of the λ/4 transmission lines (25, 25′, 28, 28′) could preferably be a choke coil. In the radio frequency variable capacitance device (26; 29), an impedance element (Z) includes at least one impedance element being inserted in series, parallel or combination of series and parallel. The radio frequency variable capacitance device can be a varactor diode.

According to another embodiment of the present invention, the inventive envelope tracking amplifier is applied to a mobile terminal device for improving the efficiency of performance.

A method of improving efficiency for the envelope tracking amplifier of the present invention, comprising a DC bias voltage supply unit (1) with a DC-DC converter for applying dynamic DC bias voltage depending on the variation of the RF input signal; an envelope tracking amplifier generating a RF output to improve the efficiency by dynamically shifting the operating point of active element (23) of power amplifying unit (10), the method comprises the steps of: a step of extracting the RF input or output signal; a step of detecting the envelope signals from the previously extracted signals (P_{D}); a step of controlling or adjusting the detected signal (P_{DE}); a step of correcting the impedance of input, output or input/output of active element (23) being applied the controlled signals (P_{C}, P_{C}′) to at least one of the radio frequency variable impedance device (26 or 29); and a step of matching with the mating input, output or input/output according to the corrected input or output impedance of active element for the varying either one of signal level of RF signal or operating point of amplifier, or both.

Accordingly, the mobile communication terminal device adopted the conventional envelope tracking amplifier circuit has a negative effect to the overall efficiency due to mismatching of input/output of power amplifier caused from the variation of supplying voltage of DC-DC converter.

Contrary, the present invention being modified with a simple configuration has an advantage to improve a stability of amplifier due to enhancement of the reflect coefficient due to the matched impedance. The gain of amplifier is also improved due to the effect of matched impedance applying the radio frequency variable capacitance device. Eventually, the overall efficiency of the amplifier is improved. The effect of the battery life is also extended doubled.

### BRIEF DESCRIPTION OF THE DRAWINGS

FIG. 1 illustrates an actual probability distribution of output power level of first conventional mobile terminal device.

FIG. 2 illustrates a shifting of operating point according to the variation of the DC bias of second conventional RF amplifier.

FIG. 3 is a circuit diagram of envelope tracking amplifier of second conventional mobile terminal device having a DC-DC converter for improving the efficiency.

FIG. 4 is a preferred embodiment of the present invention illustrating a circuit for correcting a matching circuit according to the impedance variation of active element when the supplied DC is varied by a DC-DC converter.

FIG. 5a is another preferred embodiment of the present invention illustrating an example of input impedance correcting circuit for correcting the impedance variation of active element.

FIG. 5b is another preferred embodiment of the present invention illustrating an example of output impedance correcting circuit for correcting the impedance variation of active element.

FIGS. 5c and 5d are modified the examples of FIGS. 5a and 5b.

FIGS. 6a to 6d are other preferred embodiments of the present invention illustrating the impedance element being connected to the radio frequency variable capacitance device.

FIG. 6b is an alternative example illustrating the elements being connected in parallel.

FIG. 6c is an alternative example illustrating the elements being connected in series.

FIG. 6d is an alternative example illustrating the elements connected to the variable capacitance device in series and parallel.

FIG. 7a is another preferred embodiment of the present invention illustrating an example of input impedance correcting circuit for correcting the impedance variation of active element.

FIG. 7b is another preferred embodiment of the present invention illustrating an example of output impedance correcting circuit for correcting the impedance variation of active element.

FIGS. 7c and 7d are modified the examples of FIGS. 7a and 7b.

FIGS. 8a and 8b illustrate the signal waveforms extracted from the directional coupler for the low and high power, respectively.

FIGS. 9a and 9b illustrate the dynamic DC bias voltage waveforms supplied to the drain of MESFET for the small and large signals, respectively

FIG. 10 illustrates the impedance variation of the Smith chart for the small and large signals of FIGS. 8a and 8b.

FIG. 11 illustrates the detecting signals of static amplitude detector for the small and large signals of FIGS. 8a and 8b.

FIGS. 12a and 12b illustrate the examples of waveforms of DC amplifier for the small and large signals of FIGS. 8a and 8b, respectively.

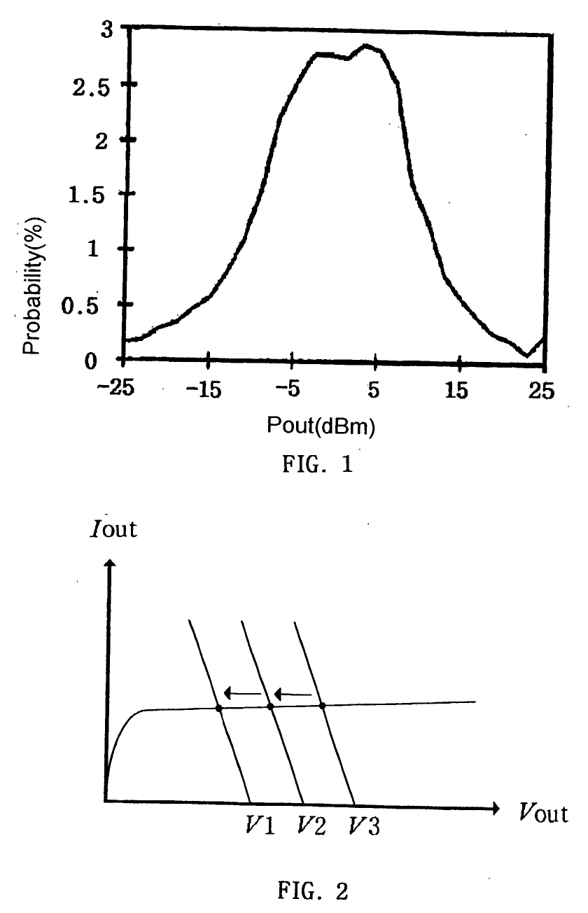

### DETAILED DESCRIPTION OF THE PREFERRED EMBODIMENTS

Hereinafter, the preferred embodiments of the present invention are described in detail accompanying with the attached drawings.

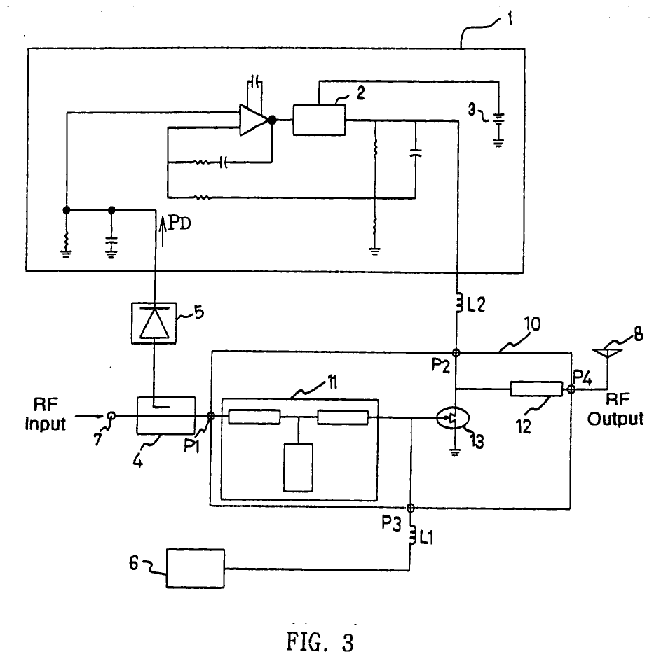

First of all, a conventional circuit containing an envelope tracking amplifier being supplied with variable bias DC voltage by a DC-DC converter (1) is described with referring to FIG. 3 for comparison purposes with the present invention.

A RF input signal is inputted from a RF signal input terminal (7) for amplifying through a power amplifying unit (10). The amplified RF output signal is outputted through an antenna (8). The power amplifying unit (10) includes a MESFET (13) being connected to a RF input terminal (7) through a terminal P1 and an input matching circuit (11). The MESFET (13) is further connected to the antenna through a terminal P2 and terminal P4.

The input matching circuit (11) is connected to a gate of MESFET (13). An output matching circuit (12) is connected to the drain of MESFET (13). Each of gate and drain of MESFET (13) is simultaneously connected to an Vgg voltage supply (6) supplying the Vgg bias voltage through a terminal P3, and an Vdd voltage supplying unit (1) supplying the Vdd bias voltage through terminal P2, respectively. Each of AC cutoff inductors (L1, L2) is inserted between the Vgg voltage supply (6) and terminal P3, and the Vdd voltage supplying unit (1) and terminal P2, respectively. A directional coupler (4) is inserted between the RF signal input terminal (7) and terminal P1 for detecting the RF input signals. The detected input signals detect the envelopes through the envelope detector (5).

An Vdd DC current dependable on the magnitude of detected envelope signal (P_{D}) is inputted to the drain of MESFET (13) as a bias voltage.

The variable Vdd voltage supplying unit (1) includes the DC-DC converter (2), the voltage supplying source (3), amplifier and a plurality of resistors and capacitor elements as depicted in FIG. 3.

Accordingly, if the output power of terminal device decreases as depicted in FIG. 2, the DC voltage and current vary adequately to decrease the DC bias power. Thereby, an operating point is moved to leftward. If the output power of terminal device were increased, the operating point would be moved to rightward. Thereby, the efficiency of terminal device could be improved.

As discussed above paragraphs, the input/output impedance of active element (10) is vaned according to the variation of DC bias voltage and current in the envelope amplifier circuit of FIG. 3.

A preferred embodiment of the present invention, a circuit of the envelope amplifier circuit containing a matching circuit according to the impedance variation of active element as shown in FIG. 4 is replaced in stead of the power amplifying unit (10) of FIG. 3.

A preferred embodiment of the present invention, as shown in FIG. 4, a circuit diagram for correcting the impedance of active element is disclosed by using a varactor diode as a radio frequency variable capacitance device. The connecting terminals P1, P2, P3 and P4 of power amplifying unit (10) as shown in FIG. 3 are identical with the corresponded connecting terminals of FIG. 4. Therefore, the descriptions of them will be omitted. The bias voltage of the circuit is designed to vary according to the power level of the power amplifier by the DC-DC converter, which is same as previously described.

Here, a weak RF signal is received at the input terminal (P1) of power amplifying unit by using a directional coupler (14). When the signal (P_{D}) transmits to the detector (15), it transforms to a DC signal (P_{DE}) proportional to the magnitude thereof. This signal will further transform to a required magnitude of DC signal via a DC controller such as the DC amplifier (24,27). Here, the DC amplifier is possibly designed as a operating amplifier or other sorts of active elements. Moreover, the DC controller of the present invention is not limited to an amplifier. It is possible to adjust the magnitude of amplitude lower or control the magnitude adequately depending on the circumstance.

First, an output terminal (C) of DC amplifier (24) is connected to the input impedance correcting circuit (100) being inserted between the directional coupler (14) and input matching circuit (21) through another two connecting terminals (A, B). The input impedance correcting circuit (100) is preferably connected to the directional coupler (14) and input matching circuit (21) disposing between the DC cutoff capacitors (C3, C4).

Same as above, an output terminal (F) of DC amplifier (27) is connected to the output impedance correcting circuit (200) being inserted between the output matching circuit (22) and RF output terminal (P4) through another two connection terminals (D, E). The output impedance correcting circuit (200) is preferably connected to the output matching circuit (22) and RF output terminal (P4) disposing between the DC cutoff capacitors (C5, C6).

More specifically, an output of DC amplifier (24) is applied to a varactor diode (26) which is a nonlinear semiconductor element through the λ/4 transmission line (25). The connecting point of λ/4 transmission line (25) and the varactor diode (26) is simultaneously connected to the directional coupler (14) and input matching circuit (21), respectively.

The output of DC amplifier (27) is applied to a varactor diode which is a nonlinear semiconductor element through the λ/4 transmission line (28). The connection point of λ/4 transmission line (28) and varactor diode (29) is simultaneously connected to the RF output terminal (P4) and output matching circuit (22).

In this case, the bypass capacitors (C1, C2) are connected to the end of λ/4 transmission line to cutoff the current of RF signal on the bias line of varactor diode. Moreover, the bypass capacitors (C1, C2) could be used as a part of matching circuit. The other end of bypass capacitors (C1, C2) and varactor diodes (26, 29) are grounded.

If the choke coils were used as the λ/4 transmission line, it would work same as the present λ/4 transmission line.

In this preferred embodiment, a special directional coupler (14) and detector (15) are separately used similar to the directional coupler (4) and detector (5) of FIG. 3. The input (P5) of DC amplifiers (24, 27) could be connected to the detector (5) of FIG. 3. Moreover, the Vdd bias output voltage of the Vdd voltage supplying unit (1) of FIG. 3 could be the input for the DC amplifier (24, 27).

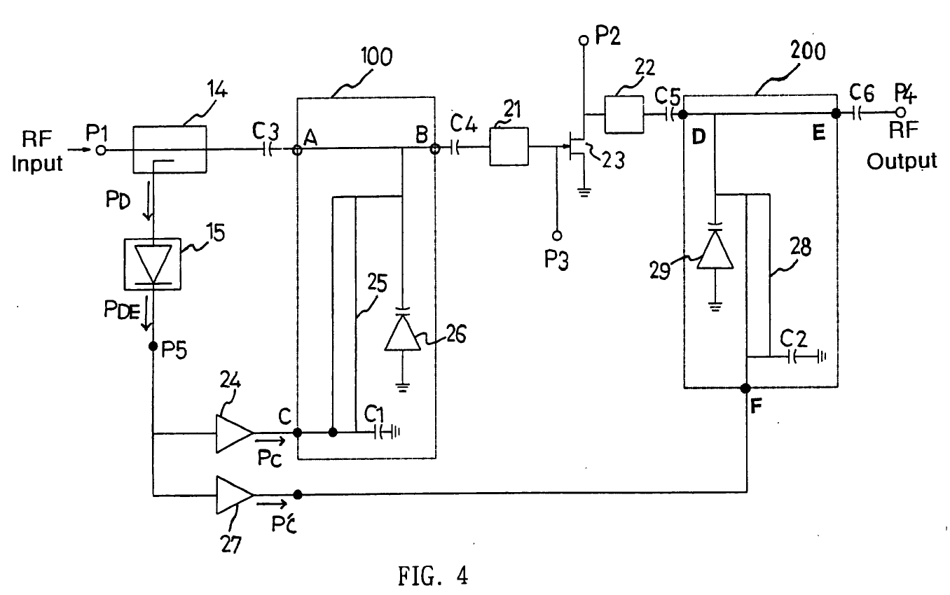

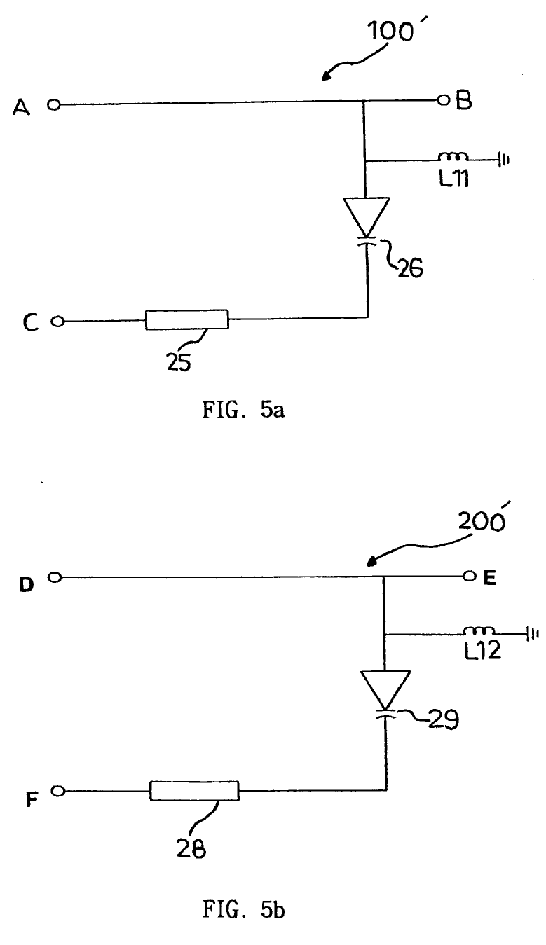

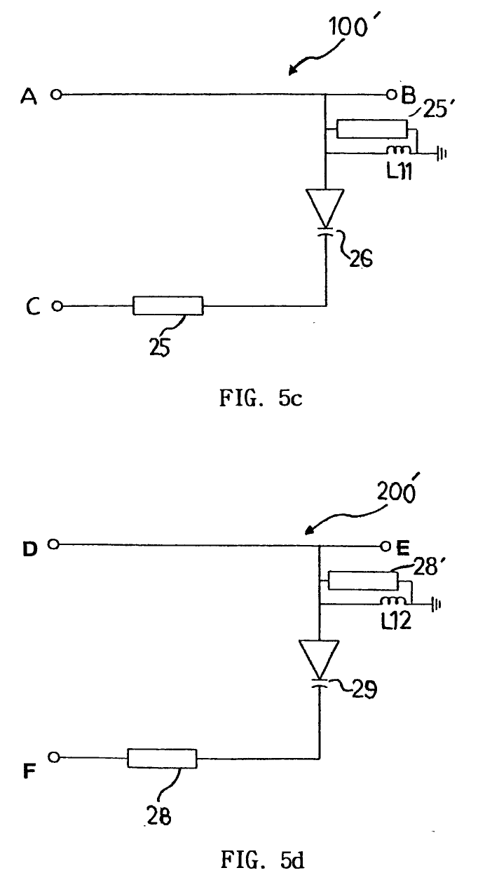

According to another preferred embodiment of the present invention, the input/output impedance correcting circuits (100′, 200′) are depicted in FIGS. 5a and 5b, respectively.

As depicted in FIG. 5a, the output terminal (C) of DC amplifier (24) is applied to the varactor diode (26) which is a nonlinear semiconductor element through λ/4 transmission line (25). The varactor diode (26) is connected to the connection of the directional coupler (14) and input matching circuit (21).

The input impedance correcting circuit (100′) is also preferably connected to the input matching circuit (21) and DC cutoff capacitors (C3, C4).

Similarly, the output end (F) of DC amplifier (27) is applied to the varactor diode (29) which is a nonlinear semiconductor element through λ/4 transmission line (28). The varactor diode (26) is connected to the connection of the RF output terminal (P4) and output matching circuit (22).

In this case, an inductor (L11 or L12) is connected to the varactor diode (26 or 29). The other end of each inductor (L11, L12) is grounded.

If the choke coils were used as the λ/4 transmission line, it would work same as the present λ/4 transmission line.

The output impedance correction circuit (200′) is also preferably connected to the output matching circuit (22), RF output terminal (P4) and DC cutoff capacitors (C5, C6).

As depicted in FIGS. 5c and 5d, on the anode side (B or E) of varactor diode (26 or 29), second λ/4 transmission line (25′ or 28′) could be connected parallel to the inductors (L11, L12) or instead of the inductors (L11, L12). One end of the second λ/4 transmission line (25′ or 28′) is grounded.

For the impedance correction circuits (100′; 200′) as shown in FIGS. 5a to 5d, it is preferable that each bypass capacitor (C1 or C2) being grounded the other end is connected to the each connection point of output terminal of DC amplifier (24 or 27) and λ/4 transmission line (25 or 28).

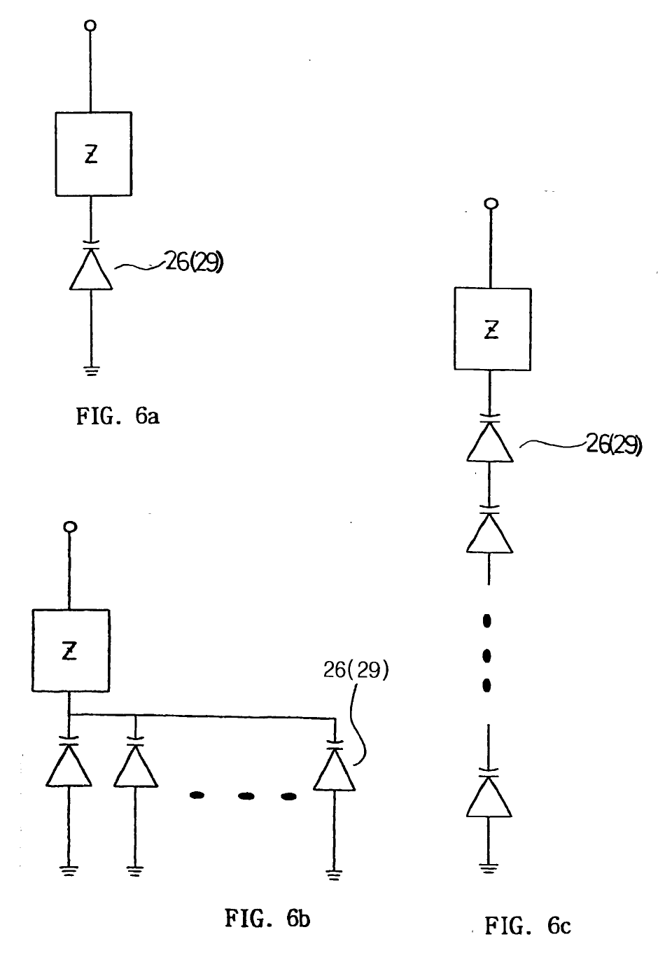

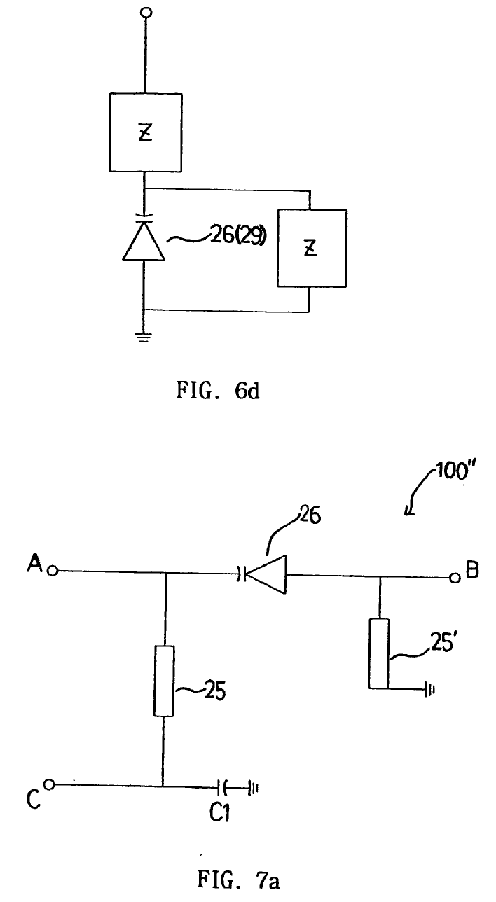

The connecting method as depicted in FIG. 4 and FIGS. 5a to 5b, the varactor diodes (26, 29) are parallel to the active element (23). As depicted in FIGS. 6a to 6c, it is possible to insert an impedance element (Z) on the cathode side of varactor diodes (26, 29).

In addition, the added impedance element (Z) could be a resisting component combined with at least one of capacitance device or inductor element. Further, as depicted in FIG. 6b, the varactor diodes (26, 29) could be combined parallel with a plurality of varactor diodes. As depicted in FIG. 6c, it could be combined series with a plurality of varactor diodes. It also could be connected a combination of series and parallel with a plurality of varactor diodes as depicted in FIGS. 6b and 6c. Besides adding an impedance element in series to the cathode side of varactor diodes (26, 29) of FIG. 6a, it is possible to add the impedance elements in parallel with the diodes (26, 29) to arrange a combination of series and parallel connection as shown in FIG. 6d.

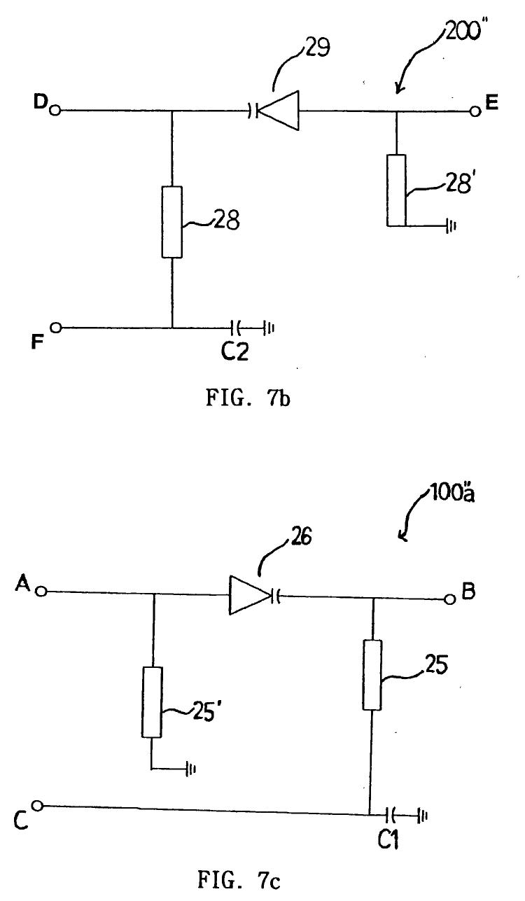

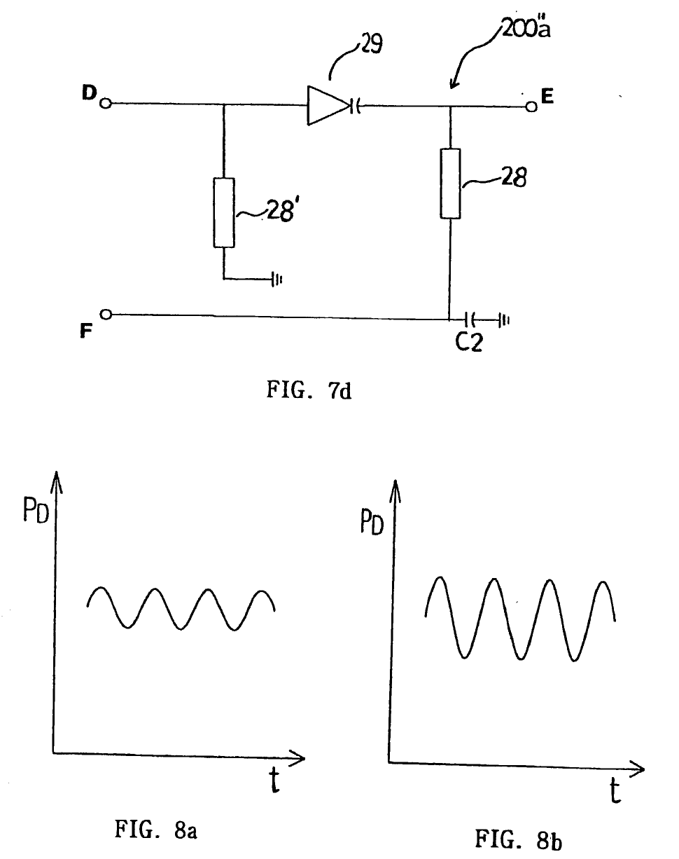

Another preferred embodiment of the present invention, the input/output impedance correction circuits (100″, 200″) are shown in FIGS. 7a and 7b, respectively.

As depicted in FIG. 7a, the output terminal (C) of DC amplifier (24) is applied to a varactor diode (26) which is a nonlinear semiconductor element through the λ/4 transmission line (25). The connection of first λ/4 transmission line (25) and varactor diode (26) are connected to the directional coupler (14) at point A, and the anode side of varactor diode (26) is simultaneously connected to second λ/4 transmission line (25′) and input matching circuit (21) at point B as shown in FIG. 7a.

The input impedance correction circuit (100′) is also preferably connected through the directional coupler (14), input matching circuit (21) and DC cutoff capacitors (C3, C4).

Similarly, as depicted in FIG. 7b, the output terminal (F) of DC amplifier (27) is applied to a varactor diode (29) which is a nonlinear semiconductor element via the λ/4 transmission line (28). The connection of first λ/4 transmission line (28) and varactor diode (29) is connected to the output matching circuit (22) at point D. The anode side of varactor diode (26) is simultaneously connected to the RF output terminal (P4) and second λ/4 transmission line (28′) at point E. At the end of first λ/4 transmission line (25, 28), a bypass capacitor (C1 or C2) is connected to cutoff the current of RF signal on the bias line. The other end of bypass capacitor (C1, C2) and second λ/4 transmission line (25′, 28′) are grounded.

Meanwhile, as depicted in FIGS. 7c and 7d different from FIGS. 7a and 7b, it is possible that the connection of first λ/4 transmission line (25, 28) and varactor diode (26, 29) are connected to the input matching circuit (21) at point B and RF output terminal (P4) at point E, respectively. The anode side of varactor diode (26, 29) is connected to the RF input terminal (P1) at point A and output matching circuit (22) at point D, respectively. At the same time, it is further connected to second λ/4 transmission line (25′, 28′). Therefore, in this case, the varactor diode (26, 29) is reverse direction against only the output of DC amplifier and right direction against the flow of RF signal.

If the choke coils were used as the λ/4 transmission line, it would work same as the present λ/4 transmission line. The output side of impedance correction circuit (200′) is also preferably connected through the output matching circuit (22) and RF output terminal (P4) and DC cutoff capacitors (C5, C6).

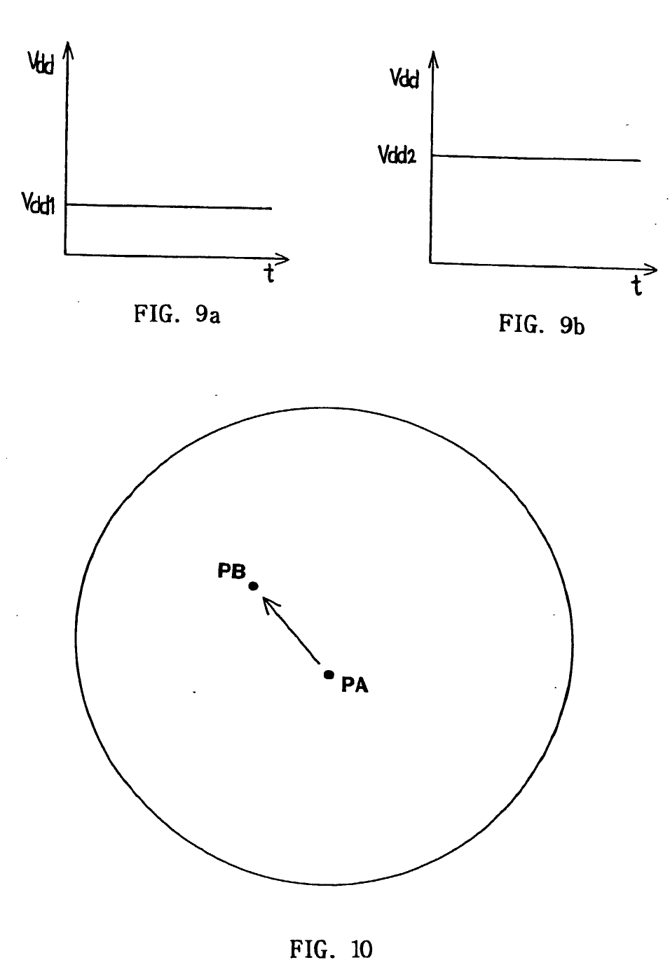

Hereinafter, the operation of the present invention will be described comparing with the conventional process. First, the operation of the conventional one is described with reference to FIG. 8 to FIG. 10. When a weak power outputs from the envelope tracking amplifier circuit of FIG. 3, the waveform being extracted from the directional coupler (4) is a tiny signal as shown in FIG. 8a. When this tiny signal is applied to the detector (5), a weak DC voltage is generated. In turn, a low bias voltage (V_{dd1}) is applied to a drain of MESFET (13) as shown in FIG. 9a.

Contrary, when a high power outputs, a big signal is extracted from the directional coupler as shown in FIG. 8b. Thus, a high DC bias voltage (V_{dd2}) is applied to a drain of MESFET (13) as shown in FIG. 9b (here, V_{dd2}>V_{dd1}).

That is, the impedance of active element (23) will be shifted from a point “PA” of Smith Chart as shown in FIG. 10 being corresponded to the cases of FIG. 8a and FIG. 9a to a point “PB” of Smith Chart as shown in FIG. 10 being corresponded to the cases of FIGS. 8b and 9b. If the impedance were varied according to the variation of bias point and power level, a circuit being matched to point “PA” would be positioned at point “PB” of non-matched position. It causes to decrease efficiency and stability of the system. Contrary, if a circuit being matched to point “PB” were at point “PA” (that is, in case of lower power), a non-matching would be occurred which is caused to decrease the efficiency and stability of system.

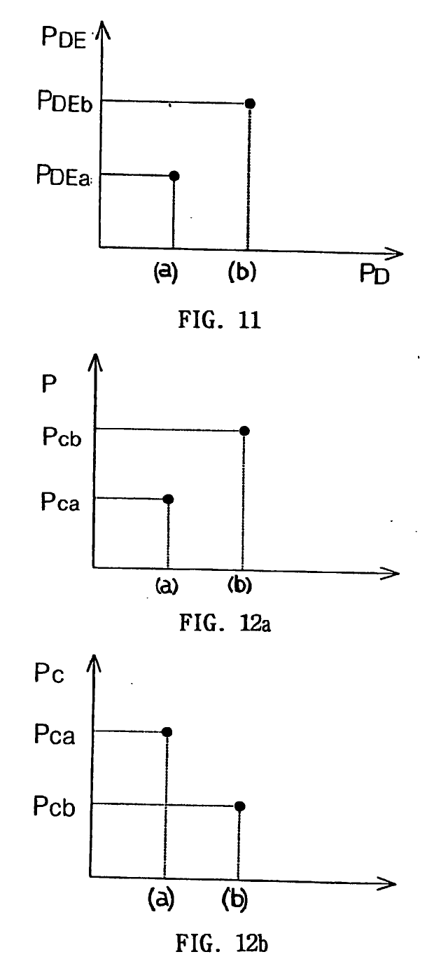

In the present invention, if the impedance were varied according to the variation of point Q (operating point) and power level, the DC signals coming from the detector would be different when the power is raised and lowered. Therefore, the signal value (P_{DE}) coming from the envelope detector of FIG. 4 is illustrated as shown in FIG. 11. That is, when a signal of envelope detector (15) is a tiny signal (refer to FIG. 8a), the DC voltage (P_{DE}) coming from the detector is represented P_{DEa}. When a signal of envelope detector (15) is a large signal (refer to FIG. 8b), the DC voltage (P_{DE}) coming from the detector is represented P_{DEb}. According to the voltage (P_{DE}) coming from the detector varies from P_{DEa} to P_{DEb}, the output of DC amplifier (24, 27) varies from P_{Ca} to P_{Cb} as shown in FIG. 12a. As a result, the input/output impedance is corrected by applying the different voltages to the variable impedance.

As shown in FIG. 12a, an impedance correction performs proportional to the signal P_{C} through the DC amplifier. On the other hand, as shown in FIG. 12b, the impedance correction performs inverse proportional to the signal P_{C} through the DC amplifier. The impedance correcting method is selectively determined either one of proportional or inverse proportional depending on the magnitude of P_{Ca} and P_{Cb} which enables to adjust within the DC amplifier. The magnitude of P_{Ca} and P_{Cb} is also possibly determined by the impedance correcting. Therefore, it is possible to correct the Smith Chart by adopting a LC circuit to the varactor diode and simultaneously applying the voltage.

In conclusion, the present invention enables to provide a radio frequency variable impedance device of biased radio frequency variable capacitance device or a variable inductance or resistance device using MEMS technology as the modified impedance by varying the DC voltage. It also enables to provide the impedance variation at the input side and output side. Thereby, it enables to match input/output by correcting the entire impedance. Further, it provides each of separated impedance for possibly correcting the impedance variation by using a plurality of impedance ends being connected to RF switch or MEMS switch.

Although the description of the present invention is cited an example of a FET as an active element, the active element could be applied to a bipolar transistor. In this case, the Vdd represents a collector bias voltage and Vgg represents a base bias voltage.

Because the RF input is corresponding to the RF output, it would be obtained a same result from a performance of impedance correction by extracting the RF output signal instead of the RF input signal. It is possible to use other sort of element such as a power divider instead of a directional coupler for extracting the RF signals. This is well known technique for the skilled person in the art.

As described above, the present invention could be applied to the field of terminal devices of mobile communication, potable multimedia or satellite communications. The input/output impedance matching is automatically performed according to the feedback of signal level variation by adding a simple configuration. Thereby, the gain of amplifier and overall efficiency are improved. The reflect coefficient is also improved for stabling the amplifier. On the other hand, it could be also applied to a base station of impedance matching.

It is to be understood that even though characteristics of the present invention have been set forth in the foregoing description, various changes and alterations may be made by those having ordinary skills in the field of the present invention without departing from the scope of the technical principles and spirit of the present invention, and therefore the scope of the invention is not limited to the foregoing preferred embodiments and attached drawings thereof and should be limited by the attached claims.

What is claimed is:

1. An envelope tracking amplifier enables to generate a RF output for improved gain by dynamically shifting an operating point of active element (23) of power amplifying unit (10), including a DC bias voltage supply unit (1, 6) which includes a DC-DC converter that applies dynamic DC bias voltage through varying RF input signal, comprises:
an extracting means (14) for extracting said RF input or output signal,
a detector (15) for detecting envelope signal from signals extracted by said RF signal extracting means (14), and
at least one impedance correcting circuit (100, 200; or 100′, 200′; or 100″ 200″; or 100″a 200″a) connected to input side, output side or input/output side of active element (23), each impedance correcting circuit including at least one radio frequency variable impedance device (26 or 29) being connected to output signal of detector,
wherein, in case of variation either one of signal level of RF signal or operating point of amplifier, or both, said active element receives input or output impedance being corrected by said impedance correction circuit to match mated input, output or input/output.

2. The envelope tracking amplifier for improving gain of claim 1, further includes a DC controller (24 or 27) for controlling signals of said detector (15), and applying controlled signals to said impedance correction circuit.

3. The envelope tracking amplifier for improving gain of claim 2, wherein, at least one impedance correction circuit (100 or 200) includes a λ/4 transmission line (25, 28) connected to one output end of DC controller (24, 27), other end of λ/4 transmission line is connected to at least one radio frequency variable impedance device (26, 29), at the same time a connection of said λ/4 transmission line (25, 28) and said variable impedance device (26, 29) is connected parallel to either one of a gate (base) or drain (collector) of active element (23).

4. The envelope tracking amplifier for improving gain of claim 3, wherein other end of said radio frequency variable impedance device (26, 29) is grounded, and a bias capacitor (C1, C2) is connected to a contacting point of output end of DC controller (24, 27) and said λ/4 transmission line (25, 28), and one end of said bias capacitor (C1, C2) is grounded.

5. The envelope tracking amplifier for improving gain of claim 2, wherein, at least one impedance correction circuit (100′ or 200′) includes a λ/4 transmission line (25, 28) being connected to one output end of DC controller (24, 27), other end of λ/4 transmission line (25 or 28) being connected to at least one radio frequency variable impedance device (26, 29) and other end of radio frequency variable impedance device (26, 29) is connected parallel to either one of a gate (base) or drain (collector) of active element.

6. The envelope tracking amplifier for improving gain of claim 5, wherein other end of radio frequency variable impedance device (26 or 29) is connected to an inductor (L11, L12), and one end of said inductor (L11, L12) is grounded.

7. The envelope tracking amplifier for improving gain of claim 5, wherein other end of radio frequency variable impedance device (26 or 29) is connected to second λ/4 transmission line (25′ or 28′), and one end of said second λ/4 transmission line (25′ or 28′) is grounded.

8. The envelope tracking amplifier for improving gain of claim 2, wherein input side impedance correction circuit (100″) includes first λ/4 transmission line (25) being connected to output end of DC controller (24), and other end of first λ/4 transmission line (25) is inversely connected to at least one radio frequency variable impedance device (26) and at the same time, connection of said λ/4 transmission line (25) and said variable impedance device (26) is connected to RF input side, and other end of radio frequency variable impedance device (26) is connected series to a gate (base) of active element.

9. The envelope tracking amplifier for improving gain of claim 8, wherein other end of radio frequency variable impedance device (26) is connected to second λ/4 transmission line (25′), and one end of second λ/4 transmission line (25′) is grounded.

10. The envelope tracking amplifier for improving gain of claim 2, wherein output side impedance correction circuit (200″) includes first λ/4 transmission line (28) being connected to output end of DC controller (27), and other end of first λ/4 transmission line is inversely connected to at least one radio frequency variable impedance device (29) and at the same time, connection of said first λ/4 transmission line (28) and said variable impedance device (29) is connected to a drain (collector) side of active element, and other end of radio frequency variable impedance device (29) is connected series to RF output side.

11. The envelope tracking amplifier for improving gain of claim 10, wherein other end of radio frequency variable impedance device (29) is connected to second λ/4 transmission line (28′), and one end of second λ/4 transmission line (25′) is grounded.

12. The envelope tracking amplifier for improving gain of claim 2, wherein the input side impedance correction circuit (100″a) includes first λ/4 transmission line (25) being connected to output end of DC controller (24), and other end of first λ/4 transmission line is inversely connected to at least one radio frequency variable impedance device (26) and at the same time, connection of said first λ/4 transmission line (25) and said variable impedance device (26) is connected to a gate (base) of active element, and other end of radio frequency variable impedance device (26) is connected series to RF input side.

13. The envelope tracking amplifier for improving gain of claim 12, wherein other end of radio frequency variable impedance device (26) is connected to second λ/4 transmission line (25′), and one end of second λ/4 transmission line is grounded.

14. The envelope tracking amplifier for improving gain of claim 2, wherein output side impedance correction circuit (200″a) includes first λ/4 transmission line (28) being connected to output end of DC controller (27), and other end of said first λ/4 transmission line is inversely connected to at least one radio frequency variable impedance device (29) and at the same time, connection of said first λ/4 transmission line (28) and said variable impedance device (29) is connected to said RF output side, and other end of radio frequency variable impedance device (29) is connected series to a drain (collector) side of active element.

15. The envelope tracking amplifier for improving gain of claim 14, wherein other end of radio frequency variable capacitance device (29) is connected to second λ/4 transmission line (28′) and one end of second λ/4 transmission line (25′) is grounded.

16. The envelope tracking amplifier for improving gain of claim 1, wherein a DC bias voltage supply is inserted after said envelope detector (5).

17. The envelope tracking amplifier for improving gain of claim 5, wherein a bypass capacitor (C1, C2) is connected to said λ/4 transmission line (25, 28), and said DC controller (24, 27), and one end of said bypass capacitor (C1, C2) is grounded.

18. The envelope tracking amplifier for improving gain of claim 3, wherein at least one radio frequency variable capacitance device (26; 29) is connected in series or parallel or combination of series and parallel.

19. The envelope tracking amplifier for improving gain of claim 3, wherein said λ/4 transmission line (25, 25′; 28, 28′) is a choke coil.

20. The envelope tracking amplifier for improving gain of claim 1, wherein said radio frequency variable capacitance device (26; 29) is connected at least one impedance element of impedance element (Z) in series, parallel or combination of series and parallel.

21. The envelope tracking amplifier for improving gain of claim 1, said envelope tracking amplifier is applied to a mobile communication tenninal device.

22. A method of improving gain for an envelope tracking amplifier enabling to generate a RF output by dynamically shifting an operating point of active element of power amplifying unit (10), including a DC bias voltage supply (1) which includes a DC-DC converter that applies dynamic DC bias voltage through varying RF input signal, the method is comprising the steps of:
extracting said RF input or output signal;
detecting envelope signals from said extracted signals (P_{D})
adjusting said detected signal (P_{DE})
outputting said adjusted signal (P_{C}, P_{C}′), and
correcting impedance of input, output or input/output of active element (23) by applying said detected signal (P_{DE}) to at least one radio frequency variable impedance device (26 or 29),
matching input, output or input/output by said corrected input, output or input/output impedance of active element for a case of variation either one of signal level of said RF signal or an operating point of said amplifier or both.
